(19) United States
(12) Patent Application Publication
(10) Pub. No.: US 2012/0278434 A1
(43) Pub. Date: Nov. 1, 2012

(54) MEDIA PREDICTIVE CONSIGNMENT

(75) Inventors: ARAN ZIV, NATANYA (IL); EYAL BYCHKOV, HOD HASHARON (IL); YITZHAK POMERANTZ, KFAR SABA (IL)

(73) Assignee: SANDISK IL LTD. (FORMERLY MSYSTEMS LTD.), KFAR SABA (IL)

(21) Appl. No.: 13/534,750

(22) Filed: Jun. 27, 2012

Related U.S. Application Data
(63) Continuation of application No. 11/642,731, filed on Dec. 21, 2006.
(60) Provisional application No. 60/762,641, filed on Jan. 30, 2006.

(51) Int. Cl. G06F 15/16

(52) U.S. Cl. 709/217

(57) ABSTRACT

A method and system for enhanced electronic delivery and sale of a content item. In order to speed delivery and avoid congestion of a delivery channel, a potential customer is identified and the item delivered prior to solicitation by the customer. Delivery is at a time when communication resources available prior to a critical time of peak demand. Delivery of the item may be enhanced via multicasting. Sale of the item is encouraged through one click context sensitive buying.

### REFERENCE TO EARLIER-FILED APPLICATIONS

This continuation application claims priority from U.S. patent application Ser. No. 11/642,731, filed Dec. 21, 2006, which claims the benefit from U.S. Provisional Patent Application No. 60/762,641, filed Jan. 30, 2006. The contents of each of these applications is incorporated by reference herein in their entirety.

### FIELD OF THE DISCLOSURE

The present disclosure relates to a method and system to deliver content to a media device.

### BACKGROUND

The sale and delivery of digital content via communication networks is well known in the art of electronic publishing and commerce. Publishers sell rights to view media content, and then deliver the content to be used in according to the purchased rights.

The typical procedure of consuming products involves the steps of selection, ordering, payment or commitment to pay, delivery and consumption—in this order.

Commonly the steps of remote purchasing of a license to consume content include

Selection—The user browses through a selection of available items, and selects a desired item.

Ordering—The user indicates his intention to purchase, for example by filling out and sending an order form.

Payment or commitment to pay—The user fills out a credit card form, or pays via other communication means.

Delivery—The user downloads the desired content from the publisher's domain into the user's playing system.

Release—The content is released for consumption on the user's system by providing the user with a password or a decryption key.

Consumption—User plays the content item according to the limitations of the license.

It should be clear that due to the easy ability to duplicate digital files on any computer, the publisher takes precautions not to leave in the hands of the user a file that can be easily duplicated and used on any computer. This is typically done by releasing the content to be consumed only when it already resides, in a its sealed state, on the user's system, and making that release specific to the user's system by linking it to a serial number of a local hardware device.

Some alterations of the above sequence are practiced in the art of digital rights management (DRM). For example payment may be by a subscription or the consumer may be able to download the content in its unusable form or in a limited use form prior to ordering.

The process described above is not claimed as a part of the present disclosure and is well known in the art, and is brought here only as background for understanding the present disclosure.

Prior art digital publishing methods as described above have two major disadvantages, one from the point of view of the publisher and one from the point of view of the user.

From the point of view of the publisher: As the downloading of the content takes place by the initiative of the user, and as in some cases a huge number of users may impulsively wish to consume the same content at the same time, the publisher may face surges of demand that are beyond the bandwidth of its distribution links. A typical example is the demand for a specific segment of video from a sports game upon announcement of an event in a news broadcast. It is expected that many listeners of the news will impulsively ask to see the video segment, creating a surge on the bandwidth of the publisher, preventing the publisher from supplying the service in real time.

From the point of view of the user: The content is downloaded after the request has been made, so the viewing by the user cannot be instant. In some cases, like in audio music, the streaming of the media content can be faster than its consumption, so that the consumption can begin after a short delay of synchronization while the content is streaming. In other cases, such as video and high quality images, the user has to wait a long period of time before he can enjoy the content.

Consignment has long been used to enhance distribution. Generally, a distributor leaves a product on consignment with a broker. If the product is sold, then the broker pays the distributor. If the product is not sold, the broker returns the product to the distributor. This traditional model has also been recommended to aid publishers distributing of electronic content (e.g. by Johnson et al U.S. Pat. No. 6,591,250). While such schemes reduce the distribution burden on the publisher, they do not entirely resolve distribution problems, for example where high transient demand may tax the communication network. Furthermore, broker consignment schemes insert a middleman into the distribution network. Particularly, in the case of electronic marketing which permits cheap direct contact between the consumer and the supplier, broker consignment makes distribution more complicated and expensive.

To alleviate the above limitations of broker consignment, various schemes exist for consignment directly to a consumer. In physical publishing, serial clubs, for example book and record clubs allow a consumer to receive a series of items and elect to buy or return the items. This serves the needs of the publisher to disseminate products but has little advantage to the consumer who must either buy the product or go to the trouble of returning it. Therefore publishers generally offer incentives (reduced prices or gifts) to consumers who sign up for the consignment club.

Such consignment to the consumer is more attractive in electronic content marketing due to two particular characteristics of electronic content: 1) electronic content is entirely virtual until placed in consumable form and therefore there is no need to return unsold products to the distributor and 2) an encrypted electronic content item can left in the hands of a consumer without compromising the property rights of the supplier and the encrypted file can be opened nearly instantly with permission of the supplier (via a few bytes of decryption information [in the form of an electronic code or key]).

Thus, in electronic publishing it is common to consign a content item (a picture, movie, book or computer program) in a sealed (unusable form) or in a partially usable form (for sections of a book are locked or certain functions of a computer program are disabled) or in a temporary form (that may be used freely for a trial period [usually of 30 days] and then is automatically sealed to prevent further use). In the cases of partially usable or temporarily usable content, limited use of the content is the bonus that the consumer receives for agreeing to the consignment. The user may then elect to pay for the content and unlock full functionality.

Previous art consignment schemes have significant drawbacks even for electronic content items. Serial schemes in which a publisher sends a set of materials to a customer and simultaneously notifies the customer of the option to buy the content are inconvenient and annoying to many consumers who do not wish to receive notification of delivery of an item that they did not order at a time that they do not need the item. A user does not wish to receive and delete from his computer constant irritating notices of (mostly unwanted) new content that is being consigned to him. On the other hand, many consumers do not want to search out the material and solicit the supplier as is necessary in directly solicited consignment schemes. Thus, previous art consignment schemes deprive the consumer of easy hassle free access to desired material and deprive the publisher full distribution of his material.

In order to provide a more convenient consignment service to the consumer, blind solicited consignment has been introduced. Thus, when a consumer acquires one object (a parent item, for instance a computer program) a second object is consigned to the consumer without the consumer's direct involvement. For example, when a consumer solicits and acquires a computer program, the program is delivered with non-functional utilities. When the user tries to use one of the non-functional utilities, the user is prompted with a notification that he may enable the utility by buying a key from the supplier. Along these lines Clement (U.S. Pat. No. 7,013,598) suggests that when a buyer solicits and acquires a new computer, a set of software utilities be packaged in the free memory. When the user feels a need for one of the utilities, he can activate the utility via a decryption key to be ordered from the supplier. Thus blind solicitation scheme gives a user hassle free access to electronic content. Nevertheless, blind solicitation is limited in that the content is determined at the time of solicitation of the parent item. Thus, a user needs have changed may require content items not originally included in the parent item. Delivery of such a content item will only be upon a new solicitation forcing the user to wait for delivery after the user already feels a need for the item and forcing the supplier to deliver on demand limiting the possible of load balancing in the delivery system. Simultaneously, blind solicitation schemes consign items according to the parent item solicited without directly accounting for the needs of a particular consumer. Thus, in prior art blind consignment, either a lot of memory is wasted loading a large quantity of programs to fulfill the needs of a variety of users, or many users will find that the applications that interest them are not available. Furthermore, a user may need an application only a long time after solicitation of the parent item. Then the application takes up space in the memory of the user's device for a long time.

There is thus a widely recognized need for, and it would be highly advantageous to have, a method of consumer consignment to achieve load leveling for the publisher and instant access (without unnecessary wait downloading files) for electronic publishing. This method should be flexible enough to predict user demand based not only on direct solicitation but also by prediction of needs of a particular consumer. Furthermore, the method should facilitate downloading of items a short time before the item is needed.

The current disclosure fulfills this need by providing a method of consignment of a content item based on prediction of user demand. An item is consigned without need for solicitation by the consumer and consignment is based on both fixed user attributes and context dependent factors such as transient buying trends of the consumer and associated persons and current location and activities of the consumer.

### SUMMARY

The present disclosure is directed to a method and system to achieve distributor load leveling and consumer instant access in a delivery system. Particularly, in a particular embodiment, the present disclosure teaches a method and system to predict demand and deliver content via an electronic medium prior to demand such that upon demand the content is already available to the consumer. Thus, the consumer benefits from instant on demand access, and the publisher avoids peaks in demand that swamp the delivery.

According to the teachings of the present disclosure there is provided a method for enhanced electronic delivery of a content item. The method includes the steps of identifying a potential consumer for the content item and delivering a file associated with the content item unsolicited by the potential consumer.

According to the teachings of the present disclosure there is also provided a method for a publisher to sell to a consumer a replay of an event. The replay includes a portion of a broadcast content. The method includes the step of caching the portion of the broadcast content on a device (for example a local memory of the consumer's viewing device) available to the consumer during a broadcast of the content. The method also includes the step of providing the consumer with an interface with which to request the replay. The request is also interpreted as an agreement to pay for the replay. Upon agreement by the customer to pay for the replay, the publisher provides the customer with the means to release the replay for consumption.

According to the teachings of the present disclosure there is also provided a system to enhance delivery of a content item to a viewing device of a consumer. The system includes a first algorithm to identify the consumer even before the consumer solicits the seller and a second algorithm to forecast a critical time for delivery of the content item to the consumer. The system further includes a local storage associated with the viewing device of the consumer. The local storage serves to store the content item after delivery and prior to the critical time.

According to further features in preferred embodiments of the disclosure described below, in the method for enhanced delivery of a content item, the step of delivering is according to a priority scheme.

According to still further features in the described preferred embodiments, in the method for enhanced delivery of a content item, in the priority scheme, priority is assigned according to an attribute of the potential customer or a nature of the content item or a current time or a time of notification or an expected availability of a bandwidth at the time of notification.

According to still further features in the described preferred embodiments, the method for enhanced delivery of a content item further includes the step of prognosticating an optimal time for notifying the potential customer of the availability of the content item.

According to still further features in preferred embodiments of the disclosure described below, the method for enhanced delivery of a content item further includes the step of forecasting a critical time for delivering the content item. The step of delivering is then previous to the critical time.

According to still further features in preferred embodiments of the disclosure described below, in the method for enhanced delivery of a content item, the critical time is a beginning of a period when the potential consumer is expected to desire the content item.

According to still further features in the described preferred embodiments, in the method for enhanced delivery of a content item, the critical time is a beginning of a period when a congestion is expected in a delivery channel.

According to still further features in the described preferred embodiments, in the method for enhanced delivery of a content item, the critical time is the time of a peak in expected demand for the content item.

According to still further features in the described preferred embodiments, in the method for enhanced delivery of a content item, the critical time is a time at which there is to be a media broadcast associated with the content item.

According to still further features in the described preferred embodiments, in the method for enhanced delivery of a content item, the step of identifying a customer is prior to solicitation by the potential consumer.

According to still further features in the described preferred embodiments, in the method for enhanced delivery of a content item, the content item is delivered to the potential customer prior to solicitation by the potential consumer.

According to still further features in the described preferred embodiments, in the method for enhanced delivery of a content item, the delivery of the content item is by multicasting.

According to still further features in the described preferred embodiments, in the method for enhanced delivery of a content item, the file containing the content item is delivered in a sealed format. The sealed file is released upon a request by the consumer.

According to still further features in the described preferred embodiments, in the method for enhanced delivery of a content item, the request for the content item is interpreted as an agreement to pay for the content item.

According to still further features in the described preferred embodiments, the method for enhanced delivery of a content item further includes the step of sending a datum associated with the content item to the consumer after the consumer requests the content item.

According to still further features in the described preferred embodiments, in the method for enhanced delivery of a content item, the step of identifying a customer is based on a historical loyalty. Consumer loyalty is recognized according to the consumer's history of buying items associated with the content item or according to the consumer's belonging to a group associated with the item or according to espoused interest in the item. The loyalty may be to the performer featured on the item, to the genre of the item, to the author of the item or to a bestseller list (for an item featured on the list).

According to still further features in the described preferred embodiments, in the method for enhanced delivery of a content item, the step of identifying a potential consumer is based on the current location of the potential consumer, the current time, the current day, attendance of the potential consumer at an event associated with the content item, or the fact that the potential customer is currently viewing a content associated with the content item.

According to still further features in the described preferred embodiments, in the method for enhanced delivery of a content item, the step of identifying a potential consumer of the content item is based on an exceptional trend of purchasing by a person associated with the potential consumer, a result of data mining of available parameters and user profiles, a recommendation of a commissioned investigator, or a user generated self-profile.

According to still further features in the described preferred embodiments, the method for enhanced delivery of a content item further includes the step of sending a second content item associated with the content item to the potential consumer after the critical time.

According to still further features in the described preferred embodiments, the method for enhanced delivery of a content item also includes the step of deleting a file from a storage when the period in which the potential consumer is expected to desire the content item has passed or when a period of an expected congestion in a delivery channel has passed or when a change in the status of the potential consumer reduces the expectation that the potential consumer will buy the content item or when the publisher wants to store an alternative content item in the local storage of the user.

According to still further features in the described preferred embodiments, in the method for enhanced selling a replay, the catching of the broadcast content is in an encrypted format. Thus, releasing the replay includes providing the consumer with an encryption key.

According to still further features in the described preferred embodiments, in the method for selling a replay, the step of releasing includes delivering a content item to the consumer. Then the replay includes both the cached portion of the broadcast and also the content item.

According to still further features in the described preferred embodiments, the system for enhanced delivery of a content item also includes a single key by which the consumer communicates a request to buy the content item.

According to still further features in the described preferred embodiments, in the system for enhanced delivery of a content item, the viewing device and the local storage are co-located.

### Terminology

For the sake of the current disclosure, the following definitions are used:

Viewing device—a system or that allows a user to consume (for example hear, see, play, or feel [for example via Braille or virtual reality]) a content (for example a movie, a song, a sporting event) stored or broadcast on a medium (for example a CD, a DVD, a magnetic tape, a radio wave broadcast, a microwave broadcast, a signal broadcast over a cable). The output (screen, speakers) and the storage can, but do not have to be in the same physical package. The output and the storage can be packaged in different devices, co-located or remote as long as they interconnected by a link that enables streaming of content from the storage to the output and as long as the peripheral devices (memory, screen, speakers) are accessible on demand to the playing device.

Sealed version of a content item—a file containing a content item, such as music, video or image, in a form that contains all the information but is protected from viewing by information security means such as encryption, password, token or biometrics.

Open version of a content item—a file containing a content item, such as music, video or image, in a form that can be used in accordance with a license.

Unsolicited content—content that is not being requested by a user directly (for example by explicitly ordering the content) or indirectly (for example opening a web page that unconditionally downloads the content).

Content item—substantive information or creative material that may be transmitted for sale over a communication channel; examples of content item include but are not limited to: a digital music file, an electronically stored analogue format recording, an electronic game, a graphic, a video, a computer program; examples of a communication channel include but are not limited to a telephone line, an optical cable, an infrared beam, a microwave signal.

Expected—an occurrence is more likely than usual. For the sake of this patent, expectation is not limited to mathematical expectation (mean) and expectation is not limited to a probability of occurrence greater than some fixed value (i.e. greater than 50%). Thus for the sake of the present disclosure, the statement “during the first period a consumer is expected to buy a content item” means that during the first period the consumer is considered more likely than usual to buy the content item. This does not mean or imply that that the first period is the mean expected time (mathematical expectation) and his does not mean or imply that there is greater than 50% probability that the consumer will buy the content item in the first period.

Peak—a local maximum. Not necessarily a global maximum.

### BRIEF DESCRIPTION OF THE DRAWINGS

The disclosure is herein described, by way of example only, with reference to the accompanying drawings, where:

FIG. 1 is an overview of a first embodiment of a system of the present disclosure;

FIG. 2 is simplified flowchart of the publishing process of the first embodiment of the present disclosure;

FIG. 3 is a simplified flowchart of the consuming process of the first embodiment of the present disclosure;

FIG. 4 is an overview of a second embodiment of the present disclosure;

FIG. 5 is a flowchart of a third embodiment of the present disclosure including a composite media object having both preloaded, cached and on demand loaded content items;

FIG. 6 is a flowchart of an embodiment of an algorithm to identify a potential consumer according to the present disclosure;

FIG. 7 is a flowchart of an embodiment of an algorithm to forecast a critical time according to the present disclosure;

FIG. 8 is an embodiment of a schedule for delivery of a consignment content according to the present disclosure.

### DETAILED DESCRIPTION

The present disclosure describes a method to predict demand and deliver a content item over an electronic medium prior to solicitation such that upon demand the item is already available to the consumer. Thus, a consumer benefits from instant on demand access, and the publisher avoids peaks in demand that swamp the delivery system (for instance bandwidth on an Internet connection).

The principles and operation of a method to achieve distributor load leveling and consumer instant access in a delivery system according to the present disclosure may be better understood with reference to the drawings and the accompanying description.

The present disclosure uses idle time of a network connecting a publisher to at least one user who is a consumer of a content item, and free storage space on a playing device of the user. The method uses prediction rules to forecast future demand of the content item. The content item is then sent to be stored in a sealed version on the local storage on the playing device according to availability of the content and availability of network bandwidth and the availability of local storage space in the playing device. The content item is sealed using well-known DRM methods so that the item cannot be viewed without being released by the publisher, upon ordering and commitment to pay.

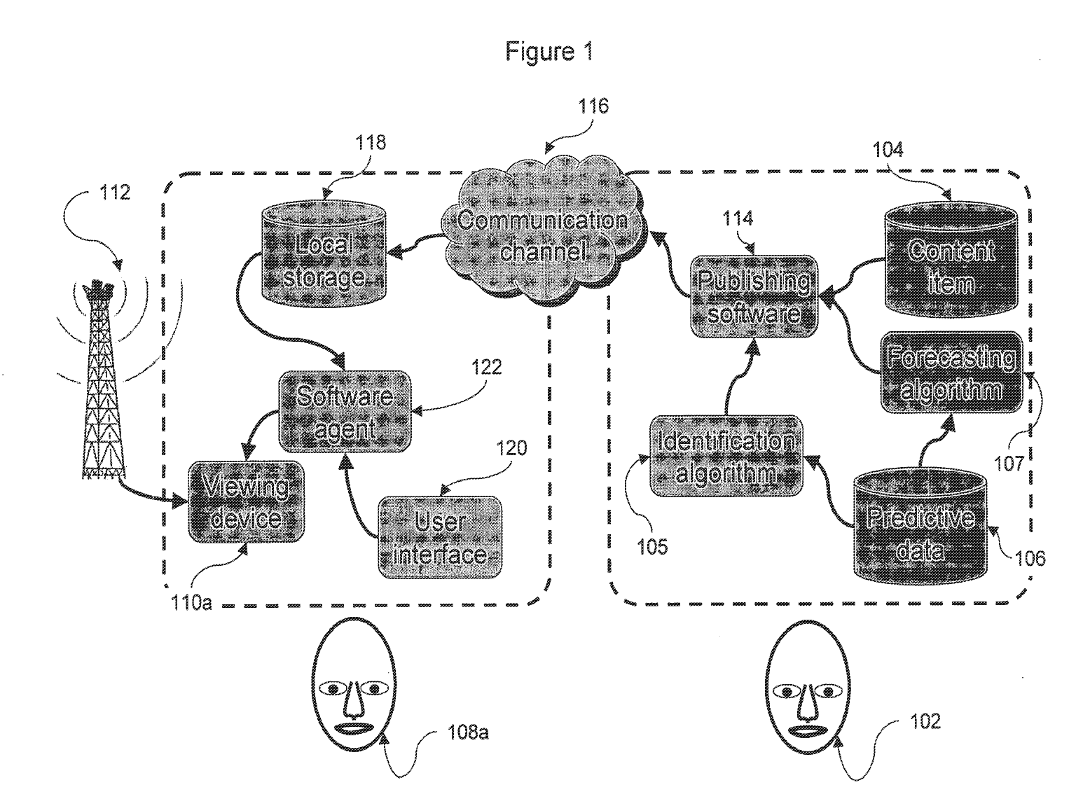

Attention is now called to FIG. 1, which is an overview of a first embodiment of the system of the current disclosure. A publisher 102 intends to sell a content item 104, a replay of the last touch down of a Washington Redskins football game. The touch down occurred at 6:43 pm. A forecast algorithm 107 predicts that a peak demand for the replay will occur at 8:15 pm when an advertisement for the clip is to be aired after the sports portion of the 8:00 network newscast. Publisher 102 employs an identification algorithm 105 which, based on predictive data 106, identifies a user 108a as a potential consumer. Specifically in the example of FIG. 1, user 108a is expected to view a broadcast on a second medium 112 (for example, a report on a football game during a news show being broadcast over a cable TV network) on a viewing device 110a during a fixed time period (for example during the sports portion from 8:12-8:14 of the 8:00 newscast). Based on data 106, which includes the facts that user 108a is a Washington D.C. resident and that user 108a has bought Redskins paraphernalia on the Internet and that user 108a subscribes to cable 1 TV network and that the son of user 108a has a part in a high school play which ends at 7:30 pm ((and is likely to miss the 6:43 segment of the game), identification algorithm 105 instructs publishing software 114 to wrap content item 104 in a encrypted file and send it over communication channel 116 to a local storage 118 associated with viewing device 110a at 8:10 pm prior to the sports section of the news report at 8:12 pm and prior to an advertising spot bought by publisher 102 to be aired during the newscast at 8:15 pm.

Local storage 118 may be a dedicated storage medium for instance an internal memory or a dedicated disk drive connected only to viewing device 110a, or local storage 118 may be a network storage device in high-speed LAN connection to viewing device 110a. Similarly, local storage may be co-located in the same location (building) as viewing device 110a or alternatively may be located at a remote location and connected to viewing device 110a over a dedicated channel.

While viewing the evening news, user 108a decides that he would really like to see the final goal of the Redskins Giants game. All of a sudden, a commercial advertises the availability of a film clip from the game to Cable 1 subscribers. User 108a can buy the clip by merely clicking the “buy2” button on a user interface 120 of the set top box of viewing device 110a. When user 108a clicks button “buy2”, a software agent 122 inside of the set top box checks an internal database (constantly updated by the cable network) to see that the “buy2” button is currently associated with content item 104 the 6:43 replay of the Redskin's game. Software agent 122 then checks if the replay is currently in local storage 118. Finding that content item 104 is currently stored in local storage 118, software agent 122, contacts publishing software 114 via communication channel 116. Software agent 122 sends and agreement to buy and a pre-stored credit card number to publishing software 114 while publishing software 114 sends to software agent 122 a password needed to decrypt packaged content item 104.

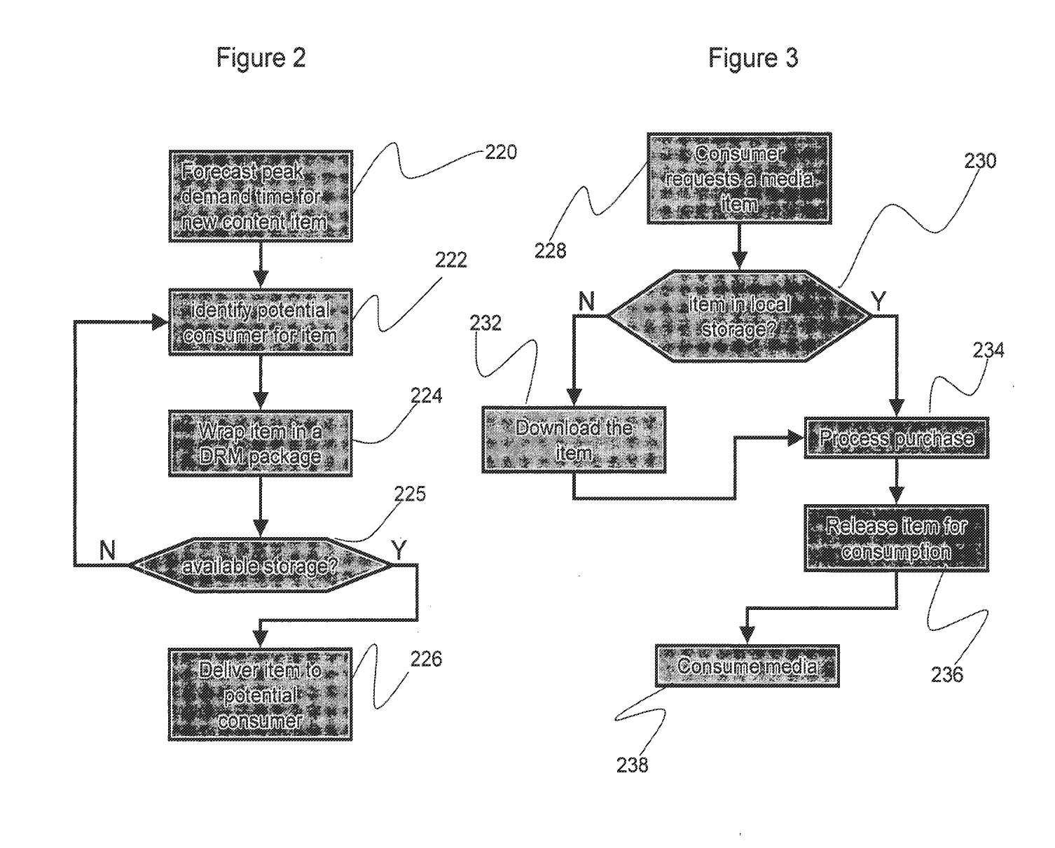

Attention is now called to FIG. 2. Forecasting algorithm 107 forecasts 220 a peaks demand for content item 104 when content item 104 is likely to be ordered by one or more consumers (for example user 108a) at 8:13 pm (when touchdown depicted in content item 104 is to be aired on a network newscast) and at 8:15 pm (when content item 104 is to be advertised during the newscast). In order to reduce bandwidth demand during a time period of high demand and in order to reduce waiting time between a request 228 for the content item 104 by a consumer and consumption 238 of content item 104 by the consumer, publisher 102 would like to deliver content item 104 to the consumer prior to the time of peak demand.

Therefore, publisher 102 uses identification algorithm 105 to identify 222 a potential consumer, for example user 108a. Publisher 102 retrieves content item 104 and seals 224 content item 104 into a packaged item so that content item 104 cannot be used before publisher 102 releases 236 content item 104. Publisher 102 then checks 225 if there is available space in local storage 118 on viewing device 110a of user 108a. User 108a has not requested content item 104, thus, publisher 102 is sending content item 104 unsolicited to user 108a. If there is available storage space, then publisher 102 delivers 226 the packaged item to local storage 118, using a low-load opportunity windows on communication channel 116 for example using broadcasting bursts. The rights of publisher 102 are not compromised by this action because content item 104 cannot be used before being released (see FIG. 3 box 236) by the publisher. Such a release will take place only upon agreement to pay for the item.

Attention is now called to FIG. 3, which is a brief illustration of the consumption of a content item according to the current disclosure. User 108a decides to purchase content item 104 for viewing on his viewing device 110a. To buy content item 104, user 108a performs the ordinary process of selecting and requesting 228 content item 104 from an offering of the publisher. A software agent 122 on device 10a checks 230 if the item has previously been delivered 226 to local storage 118 unsolicited by user 108a.

If—by way of incidence—content item 104 has not been delivered 226 to local storage 118 in advance—then content item 104 is downloaded 232 upon ordering according to conventional methods of the prior art. In such a case, the present disclosure neither helps nor disturbs the process. For example, user 108a downloads 232 content item 104 and then purchases 234 a license to view content item 104 and releases 236 content item 104 for viewing.

If, however, based on a successful predictive identification 222 of user 108a, content item 104 has already been delivered 226 to the local storage 118, then immediately upon requests 228 user 108a consumes 238 (views) content item 104 with only a small delay for processing purchase 234 and releasing 236 content item 104.

Specifically, in the example of FIG. 1-FIG. 3, a very important event occurred in a ball game at 18:43, and forecasting algorithm 107 forecast 220 that many viewers would want to buy a 60 second clip (content item 104) of the event when the event is broadcast on the news at 20:12 and when the item is advertised at 20:15. Therefore potential consumers including user 108a are identified 222 by identification algorithm 105 and content item 104 (the 60 second video clip) is sealed 224 and delivered 226 to mobile phones and set top boxes (including local storage 118 of viewing device 110a) belonging to potential consumers (including user 108a). The sealed file is saved on local storage 118 for few hours. When user 108a hears a news broadcast publicizing the event, user 108a requests 228 to buy the video clip (content item 104). Because content item 104 is already stored in consignment in local storage 118 of device 110a, then downloading 232 is unnecessary and user 108a proceeds directly to purchasing 234 a license and releasing 236 content item 104 for viewing—typically by means of a password or a key provided by publishing software 114 on purchase 234. User 108a utilizes the password to release 236 content item 104 and consumes 238 (views) content item 104.

Impulsive purchase of the content by the user can be further encouragement by allowing a “one click ordering” of the content item. Because the news—both on the radio and on television—is broadcasted sequentially, (one item of news at a time), the system can optionally provide the user with a “I want to see that!” menu-item, that indicates, during the news broadcast, if the current news item is accompanied with a video clip that is locally stored. For locally stored items, one click on this menu-item is interpreted as an order for the video item that is associated with the currently viewed news item, and the video item instantly opens for viewing, either over top (in place) of the current newscast or tiled into it.

Thus, in a preferred embodiment of the present disclosure, the act of requesting 228 a content item (for example content item 104) is accomplished by clicking a single key while the user is viewing a broadcast associated with content item 104 on a second medium 112. In the example of the first embodiment of while a news report of a football game is being viewed on viewing device 110a, software agent 122 interprets a “click” by user 108a as a purchase order for content item 104 associated with the game. If the content item 104 has been already delivered 226 and stored on local storage 118, then content item 104 is played “instantly”, without a delay for downloading the media file. User 108a watches content item 104 (for example inset onto the screen) while continuing to watch or hear the on-going second medium 112. Alternatively content item 104 can be viewed in a full screen mode, replacing the on going content of second medium 112. The same “one click” service can be associated with any other audio or video program that is associated with a locally stored media file.

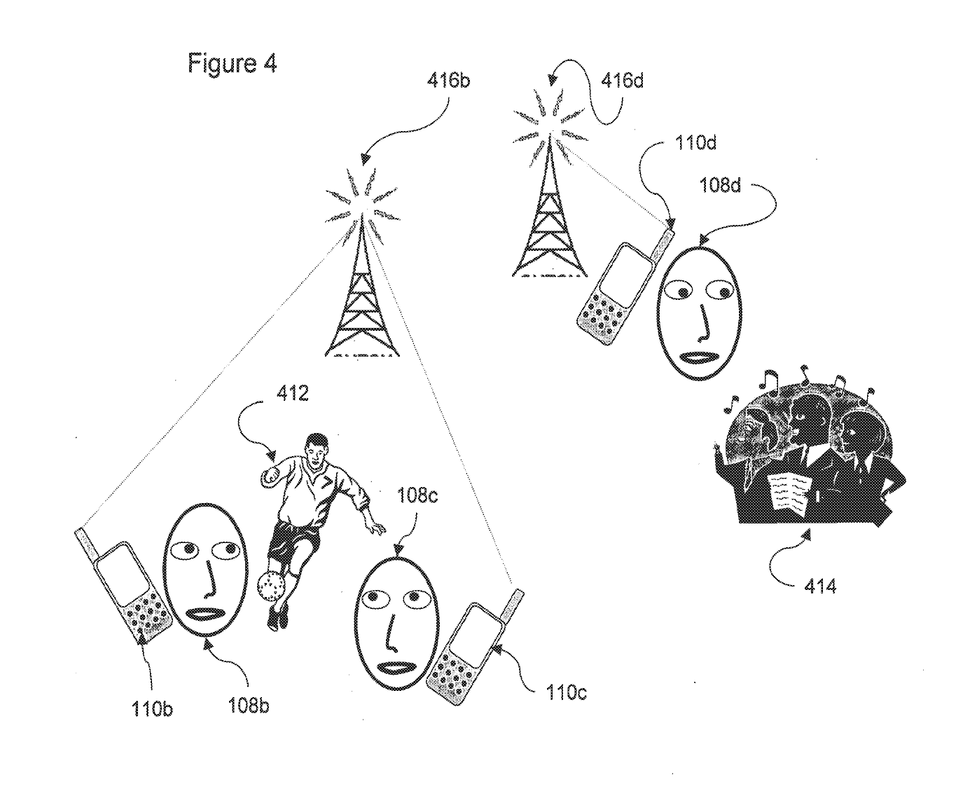

Attention is now called to FIG. 4, which is an overview of a second embodiment of the current disclosure. In FIG. 4 are illustrated three users, 108b, 108c and 108d having corresponding viewing devices 110b, 110c and 110d, which are mobile phones. User 108b and 108c are in a stadium watching a soccer match 412 whereas user 108d is sitting in a gospel concert 414. The locations of viewing devices 110b, 110c and 110d are known to a cellular phone network having local transmission/receiving antennae 416b and 416d in the vicinity of soccer match 412 and concert 414 respectively. Based on this location information and knowledge of events associated with each location, a publisher understands that during halftime of soccer match 412, user 108b, user 108c and many other users in the stadium are likely to order replays of soccer match 412 or other sporting event that occurred during soccer match 412 (since fans watching match 412 missed these other matches). Similarly during a break in the concert 414, user Hod and many other users are likely to order MTV clips or a new MP3 album from the artists of concert 414. Therefore, previous to halftime, a publisher preloads viewing devices 110b, 110c and other devices in the vicinity with clips of important events in soccer match 412 and clips from other sporting events that occurred at the same time as soccer match 412. Similarly previous to the break in concert 414, a publisher preloads viewing device 110d and other devices in the vicinity with MTV clips, albums and other media items associated with the artist in concert 414.

To further save bandwidth, rather than send the same sports clip separately to viewing device 110b and 110c, the media clip is sent once simultaneously to both viewing devices 110b and 110c via multicasting. It is understood that according to previous art techniques, a media clip is sent to a consumer on demand, and since each user 108b and 108c will request the clip at a slightly different time, the clip could not be multicast to devices 110b and 110c, but would have to be sent separately to each viewing device (110b and 110c) wasting valuable bandwidth. This would be especially problematic in the example of the second embodiment because during halftime of soccer match 412, a very large number of people will simultaneously be making phone calls and downloading data in the stadium, thus overloading the capacity of transmitter/receiver 416b. According to the present disclosure, the publisher determines a time to preload a content item to multiple devices (110b and 110c) and therefore the clip can be sent simultaneously to multiple users (108b and 108c) facilitating multiplexing. It will be understood to one familiar in the art that many of the technical problems plaguing multiplexing (black holes, loops, interception, take over) can be avoided because the multiplexed signal is being broadcast from a single transmitter to an audience (users 108b and 108c and other fans) located in a small physical area (in the stadium).

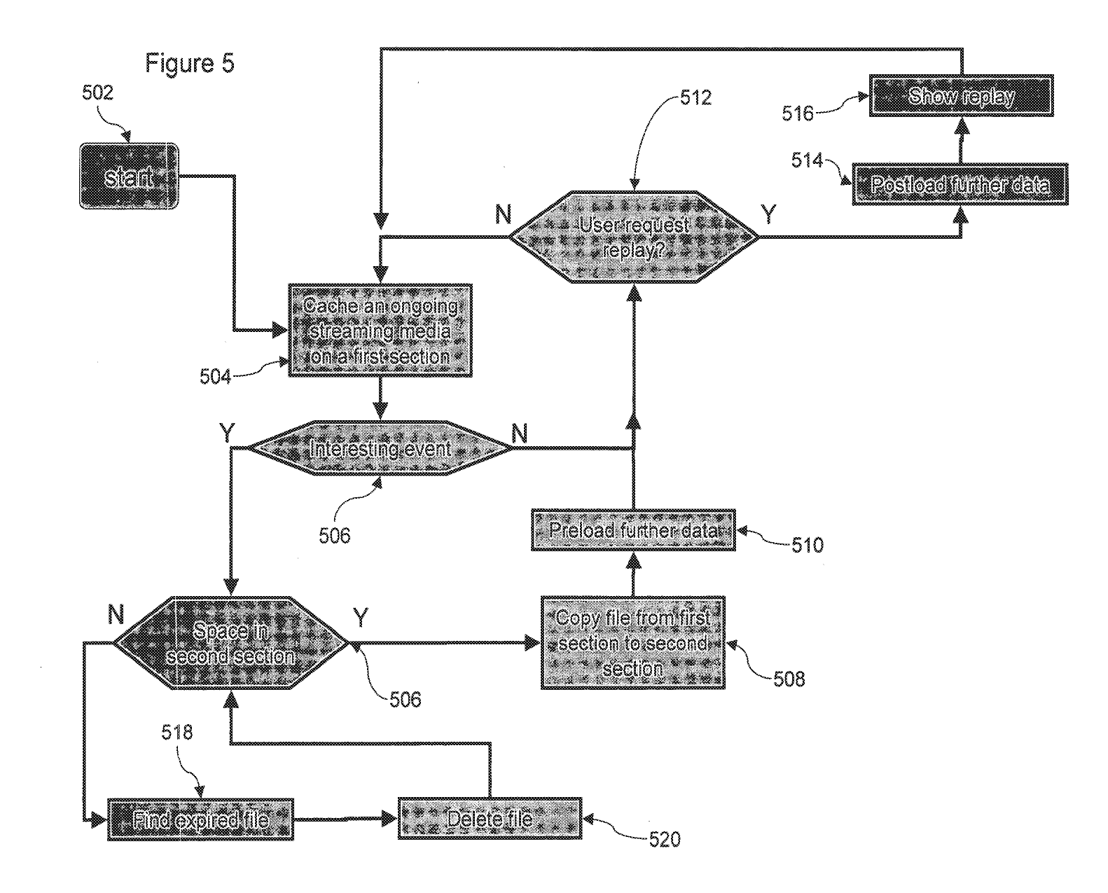

Attention is now called to FIG. 5, which is a flow chart of a third embodiment of the present disclosure. The process starts 502 by caching 504 a portion of a streaming media broadcast (in the example of FIG. 5, a football game being viewed over the Internet) onto a local storage of a viewing device (in the example of FIG. 5, the memory card of a smartphone). The viewing device belongs to a user who subscribes to a replay service of a publisher. Caching 504 an ongoing process is well known in the art of data transfer (for instance in speeding up performance of a computer disk). In the example of FIG. 5, the local storage has two sections. The first section contains a rolling image of the last minute of the game. Particularly, during a first minute a football game, a video image of the first minute of the game is cached 504 (written in a first file) and the first file is stored for a second minute while a digital video image of the second minute of the action is cached 504 on a second file. When the second minute of action is over, a third minute of action is cached 504 to a third file, overwriting the first file. Alternatively, the first section will store ten minutes of content in eleven files each file containing one minute of action, the first file being overwritten (when it becomes ten minutes old) by the eleventh file.

An agent (in the example FIG. 5 the agent is a software routine alternatively the agent may be a human operator) of the publisher constantly tracks the game determining 506 when an interesting event occurs. For example whenever the background noise (crowd cheering) passes a certain volume the agent determines 506 that the current event is interesting. Alternatively (or simultaneously) the agent also determines 506 as interesting any period of the game where points are scored or a turnover occurs or a player is hurt or the voice of the sportscaster shows signs of stress. In the case where the agent is a software routine, a copy of the routine may even reside on the viewing device of the user. When an interesting event occurs, the routine sends a message instructing the viewing device of the user to copy 508 the file containing cached images of the interesting event from the first section of storage to the second section of storage for longer-term storage.

When a period is determined 506 to be interesting, the publisher also preloads 510 further data necessary for a replay of the event to the viewing device. For example, in the case of a football game, a sealed file containing images from a particular camera having a good view of the interesting action and a diagram showing the strategy of the teams are delivered by the publisher to the viewing device at a time when there is available bandwidth on the communication channel and the sealed file is preloaded 510 to the second section of the local memory of the viewing device. Particularly in the example of FIG. 5, the communication channel is a cellular phone network.

During periods not determined to be interesting, files are not copied from the first storage section to the second section and thus as new files are stored in the first section, old files are overwritten, and the data from the uninteresting period is lost.

When a new file is to be copied 508 or preloaded 510 in the second storage section, a utility program first checks 506 if there is enough free space in the second section for the new file. If there is enough free space, then the new file is saved 508 or preloaded 510 without deleting any files. If there is not enough space, then the utility program finds 518 an expired file in the second section. For example the utility program first seeks an old file that was saved in the second section because of high crowd noise at least ten minutes ago; if such a file exists, it is deleted. Otherwise, a file is sought that was stored because of a point being scored more than thirty minutes ago; if such a file exists, it is deleted. Otherwise, an old file is sought in which a point was scored and there was loud crowd noise more than 50 minutes ago; if such a file exists, it is deleted. Otherwise, the oldest file in the second section is sought and deleted 520. Each time a file is deleted 520, the utility again checks 506 if there is enough space for the new file in the second section. Alternatively, the publisher instructs the utility program to delete a file from the second section of the local memory when the time during which the user was expected to desire the item has passed (for example as above, a reply will probably not interest the user 50 minutes after the actions). Alternatively, the publisher also instructs the utility program to delete a file when the critical time of the associated content item has passed.

At any time during the game, when the user presses the menu key on his cell phone (the viewing device), a replay menu item appears. By selecting the replay menu item, and pressing again the menu key, the user is presented with a menu of several (e.g. the last ten) interesting events in the game of the last sports web address in the user's web browser history list. For each event there is listed the time that the event occurred and what aspect of the event caused the algorithm to define the event as interesting. An eleventh menu item lets the users choose a different game from a plurality of games currently being offered by the publisher. When the user requests 512 to view a replay by choosing a replay menu item, then data is sent 514 to the viewing device containing any replay files or content items not yet cached or preloaded onto the viewing device as well as a decryption key (for example a password is placed in an appropriate settings file on the viewing device) to unlock any sealed files associated with the replay. Simultaneously, the publisher is notified and the credit card of the user is charged for the cost of viewing the replay and the replay is consumed 516 by being viewed on the viewing device.

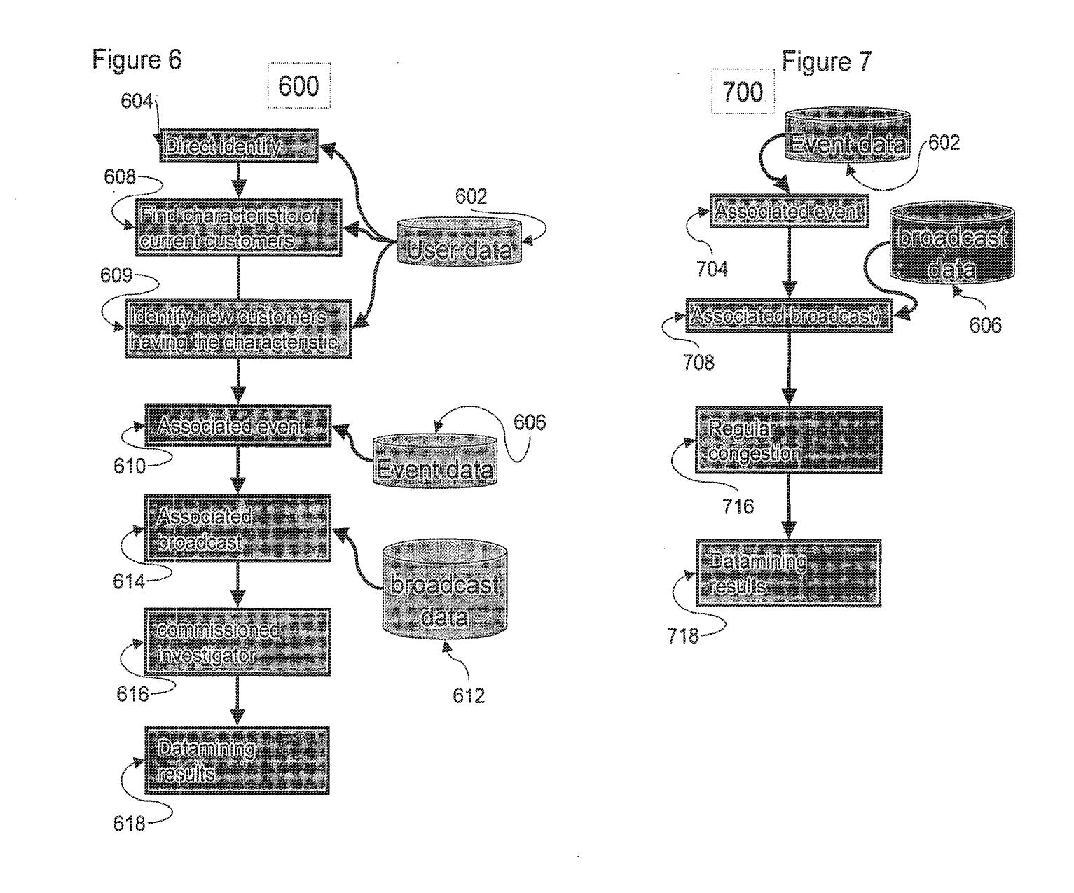

Attention is now called to FIG. 6, which is a flow chart of an embodiment of an identification algorithm 600 for identifying a potential customer according to the present disclosure. In the embodiment of FIG. 6, when a publisher has a content item to sell, he seeks to identify customers by a series of steps as illustrated.

Identification algorithm 600 starts by directly identifying 604 customers having a loyalty to an artist, a genre or a bestseller list. This is done by searching user data 602 on individuals for characteristics associated with buying the offered content. For example identification algorithm 600 searches the sales record of the publisher to identify customers who have bought associated items. For example, a publisher selling a new record by an artist uses identification algorithm 600 to directly identify 604 customers who have bought a previous recording by the same artist or recordings by artists in the same genre. Similarly if the song being sold is on a particular top seller list, identification algorithm 600 directly identifies 604 customers who have a history of buying songs from the particular list. User data 602 includes public web pages on the Internet and identification algorithm 600 directly identifies 604 a potential customer whose personal web page contains reference to the content item being sold or the artist associated with that item. Similarly identification algorithm 600 searches membership rosters of recreational groups, music classes, arts classes or fan clubs, on-line bulletin boards, petitions, organizations and chat parlors, sales records of the publisher, customer responses to advertisements, customer questions, the result of customer polls and customer self-identification questionnaire and information compiled by the publisher and bought from advertising agents to directly identify 604 a potential consumer who shows a loyalty to the artist or genre of the content item.

Identification algorithm 600 identifies further customers according to buying trends of purchasing by persons associated with the customer. Particularly, identification algorithm 600 first uses user data 602 to find 608 an attribute associated with current buyers of the content item. For example, identification algorithm 600 finds that a large portion of customers buying content from a certain artist are between the ages of twenty and twenty two and live in Spanish Harlem. Therefore the publisher identifies by association 609 a registered user aged 20 having an address in Spanish Harlem and preloads the content item to his viewing device. Similarly if it is found 608 that being a student at the University of Maryland is associated with buying comedy clips, then identification algorithm 600 identifies by association 609 a student at the University of Maryland and preloads a comedy clips to his viewing device.

Identification algorithm 600 also finds 608 transient buying trends for example exceptional trends of purchasing by users in a geographical area. Particularly, in the example of FIG. 6 a large number of people whose current location (as determined by GPS or according to the cellular network) is near a convention center are buying stock information. Therefore, algorithm 600 identifies by association 609 a user in the convention center and preloads stock information his viewing device.

Identification algorithm 600 identifies further customers by attendance 610 at an event associated with the content item. For example identification algorithm 600 searches through events schedules 606 in the sales district. Event schedules 606 may come directly from sponsoring organizations (for instance the web sight of a stadium), schedules may also come from Internet searches or from a dedicated database (for example a tourist guide or an entertainment guide). In the example of FIG. 6, when the publisher is selling a music file, identification algorithm 600 searches concert databases and electronic media for concerts of the artist associated with the music file or for other artists with similar style or of the same genre. When the publisher is selling a sports clip, identification algorithm 600 searches local gyms, playing fields, arenas and stadiums to ascertain gathering places of sports fans loyal to a team or sport associated with the media item being sold. Then customers attending the event are identified by attendance 610 using either by GPS data (according to the location of their cellular phone) or from ticket sales data or from other connected data which indicate the location of the customer, for example from sales data of shops, hotels, restaurants and gas stations in the vicinity of a sports stadium or concert hall. Another way to identify a customer attending an event 610 is to search for cellular phones whose historical record offline times correspond to concerts of the genre of a music item being sold (more specifically, a telephone owner whose phone was turned off within fifteen minutes of the beginning of the last five Rap concerts in his local area is identified as a potential customer for Rap recordings).

When there is an event associated with a particular media clip, the customer need not be identified individually. Instead, a media file is preloaded to every cell phone registered with the publisher and currently located in the vicinity of the event (without formally identifying the customer).

Identification algorithm 600 also identifies a customer viewing a media event 614 listed in a broadcast schedule 612. The current viewing content of a registered user is ascertained through an Internet cookie, which resides on the consumer's viewing device and reports to the publisher the current channel being viewed (information on the content of the channel comes from broadcast schedule 612). For example as described above in the example of the first embodiment, a sports clip is preloaded to a customer viewing the sports news. The knowledge of the current viewing of a registered user is also useful for one click shopping as described above. Alternatively, viewing patterns can be determined indirectly by tracking time patterns of the Internet connection of the viewing device or the off line time of a user's cell phone and finding correlations to an group of events listed in broadcast schedules 612.

Broadcast schedule 612 is collected from TV guides and cable guides, advertisement data, news channels and entertainment guides.

Identification algorithm 600 also identifies customers through a commissioned investigator 616. Investigator 616 is paid a fixed fee when a potential customer that he identified buys a content item. Alternatively, the pay scale of investigator 616 increases according to the proportion of actual buyers among the potential customers that investigator 616 identifies.

Identification algorithm 600 also identifies customers via datamining 618. Using known techniques (such as the WizWhy™ software product available from Wizsoft™, Tel Aviv, Israel) correlations are found between product demand and various customer attributes and times. Then a new customer is identified using user data 602 to find a user with the attribute of the found correlation.

Attention is now called to FIG. 7, which is a flow chart of a forecasting algorithm 700 for forecasting a critical time according to the current disclosure.

First forecasting algorithm 700 forecasts a critical time at the beginning time period of expected high demand for the content item resulting from an event 704 associated with the content item. Particularly forecasting algorithm 700 searches event database 602 for events associated with high transient demand for the content item. For example when the publisher is trying to sell of film clip of a NY Giants football game played on Sunday morning then a critical time is the beginning of halftime of the Washington Redskins game Sunday noon because a large number of fans are expected to spend halftime trying to catch up on other games being played Sunday morning. Similarly right after a rock concert there is expected to be a peak demand for a new recording of the artist, therefore the critical time for sending out the recording is the ending time of the concert. It should be noted that the beginning of halftime of the Redskins game is also a critical time for delivering a music file because during halftime the publisher's outgoing bandwidth is swamped with requests for the Giants game clip causing delays in delivery of the music file.

Alternatively, a critical time is associated to a particular date; for example, a clip of a scary movie is expected to have a high demand on October 31. Alternatively, a transient critical time is associated with a particular customer. For instance, sports clips are preloaded in the early evening to a particular customer who buys sports clips consistently at night between 9:00 and 10:00 PM (for example because at that time he finishes dinner and catches up on the sports events of the day).

Forecasting algorithm 700 also forecasts 704 a critical time at the beginning of a time period of an event causing general web congestion. For example the afternoon of election day from 3:00-5:00 pm EST is forecast as a time of general congestion on the entire Internet because during that period a very large number of users will be trying to view election results while simultaneously other users (who are off from work) will be surfing the net for other purposes. Therefore, the publisher preloads all kinds of files before and during Election Day.

Forecasting algorithm 700 also forecasts critical times according to an associated media broadcast 708. This is done by searching broadcast database 606 for associated broadcast items associated with the content item being sold. For example as stated above in the description of FIG. 1, the time that an event is to be mentioned on a network news broadcast is a critical time for demand for a clip of the event. Also a scheduled time for airing an advertisement for an item is forecast as a critical time for demand of that item. Similarly for an item advertised on a highway billboard, the beginning of rush hour is a critical time for demand of the item.

Forecasting algorithm 700, further forecasts a critical time for delivery of a content item according regular network congestion 716. For instance if the Internet lines are regularly congested on weekdays between the hours of 9:00-10:00 AM (when people get to work and start checking their e-mail) then the beginning of the period is forecast as a critical delivery time.

Also forecasting algorithm 700 uses datamining 718 to find times or events that are associated with high transient demand for a content item. Then the beginning of the time period when such an event is to occur is forecast as a critical time for delivery of the content item.

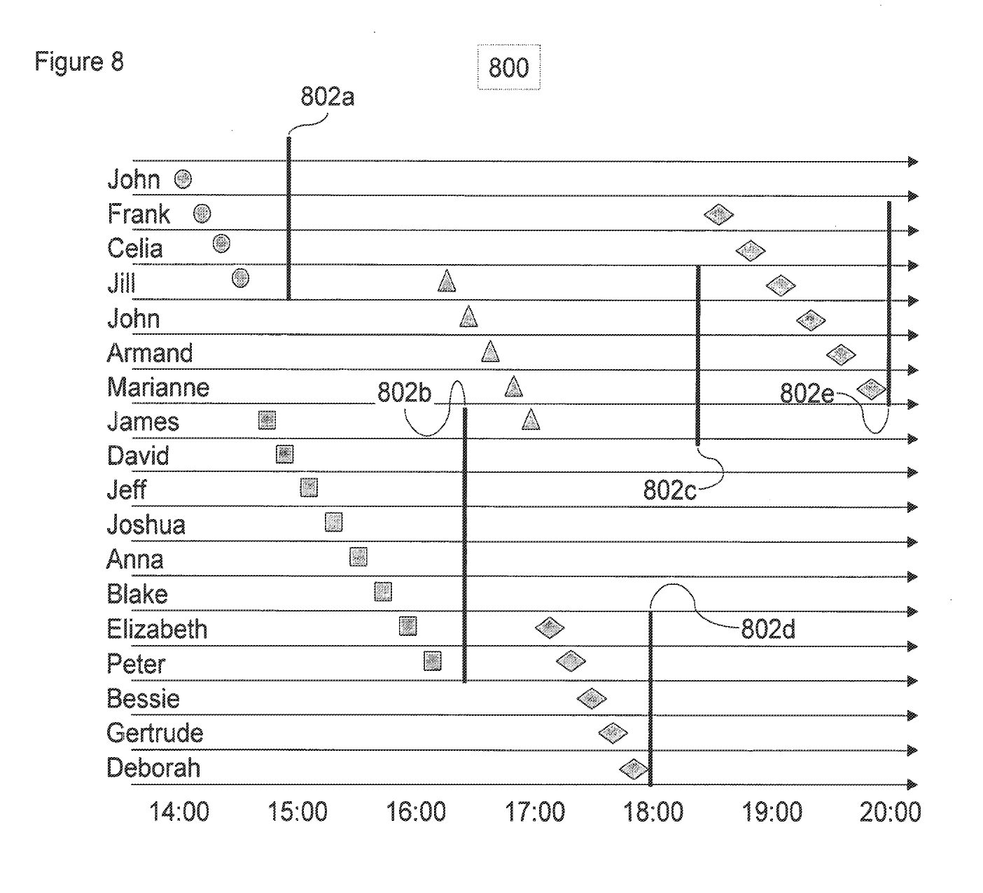

Attention is now called to FIG. 8, which is an embodiment 800 of a delivery schedule for content items according to the current disclosure. In embodiment 800 eighteen potential consumers in the Washington D.C. area, (John, Frank, Celia, Jill, John, Armand, Marianne, James, David, Jeff, Joshua, Anna Blake, Elizabeth, Peter, Bessie, Gertrude, and Deborah) are to receive one or more of 4 content items (the first item represented by a circles, the second item represented by squares, the third item represent by triangles and the fourth item represent by diamonds) on consignment in the time period represented by the horizontal access going from 14:00 (2:00 pm) to 20:00 (8:00 pm). The optimal time (15:00) for notifying particular potential customers John, Frank, Celia and Jill of availability of the first content item is represented by line 802a. The optimal time (16:30) for notifying James, David, Jeff, Joshua, Anna Blake, Elizabeth and Peter of availability of the second content item is represented by line 802b. The optimal time (18:30) for notifying Jill, John, Armand, Marianne and James of availability of the third content item is represented by line 802c. The optimal time (18:00) for notifying Elizabeth, Peter, Bessie, Gertrude, and Deborah of availability of the fourth content item is represented by line 802d. The optimal time (20:00) for notifying Frank, Celia, Jill, John, Armand and Marianne of availability of the fourth content item is represented by line 802e. In embodiment 800, an optimal time to notify each consumer (when the consumer is most likely to be interested in the item or impulsively buy the item) of the availability of a content item is prognosticated according to known attributes of the consumer as well as the nature of the content item and the context of the acquisition. Particularly, in embodiment 800, the first content item is information on the current day's closing prices and predictions of the next day's prices on European currency markets. Due to the difference in time zones, European currency markets have already closed by the morning in Washington. Therefore Washington consumers John, Frank, Celia and Jill catch up on this information and prepare orders for European currency transactions at the end of the workday and the optimal time (line 802a) to notify potential customers of the availability of the first content item is 15:00. The second content item is information on the road closings in the Washington D.C. area. The nature of traffic information dictates that consumers want the information right before rush hour when they or their spouse start their trip home from work. Accordingly the optimum time (line 802b) to notify consumers James, David, Jeff, Joshua, Anna, Blake, Elizabeth and Peter (Elizabeth and Peter are actually interested in second content item in order to predict when their spouse will arrive home) of availability of the second content item is 16:30. The third content item is information on entertainment in Washington D.C. during the current evening. According to the nature of the third content item, the optimal time (line 802c) to notify a consumers Jill, John, Armand, Marianne and James of the availability of the third content item is in the beginning of the evening at 18:30 when they are deciding what to do this evening. The fourth content item includes video clips from various news items and sports events that occurred during the current day. Accordingly, the fourth content item is expected to be of interest to consumers in the early evening when they catch up on the day's news. When the evening starts depends on attributes of the consumer. For example, the evening starts early for Elizabeth and Peter who are teachers and return home early and for Bessie, Gertrude, and Deborah (who are retired). Therefore the optimal time for notifying (line 802d) Elizabeth, Peter, Bessie, Gertrude, and Deborah of availability of the fourth content item is 18:00. On the other hand for Frank, Celia, Jill, John, Armand and Marianne who all work downtown, the evening starts late (after getting home). Therefore the time of optimum notification for the fourth content item differs for different consumers. Particularly due to the context of acquisition of news clips (that they are usually desired at the time that a consumer hears about the corresponding news item on the evening news), it is expected that Frank, Celia, Jill, John, Armand and Marianne will desire a news clip while watching the 8:00 pm news. Therefore, the optimal time (represented by line 802e) to notify Frank, Celia, Jill, John, Armand and Marianne of the availability of the forth item is at 20:00 at the beginning of the 20:00 news broadcast.

In embodiment 800 the time of delivery of a content item is determined by an “as soon as possible” rule and a priority scheme. Particularly each item is sent at as soon as there is no item of higher priority that has yet to be sent. Priority is set according to a time before notification and a maximum priority. An individual maximum priority is set for delivery of each item to each consumer. The maximum priority for delivering a given item to a given consumer takes into account the nature of the content item, an attribute of the consumer of the consumer, and the expected availability of bandwidth at the time of notification. Particularly, in embodiment 800 for times prior to the optimum time of notification, the priority of delivery is equal to the maximum priority minus the number of minutes until the time of notification. If a file is not delivered to consignment before the optimum time of notification, then the file is given a low priority for delivery to consignment after the time of notification. If a consumer solicits the content item, the priority for the item is raised to highest priority and thus delivery is as soon as possible. In the example of embodiment 800, John, Frank, Celia and Jill all have the attribute that they need the currency data for work and must receive the data before the end of the workday. Therefore for all four of these consumers, the first item has a maximum priority of 120. Also for the second content item (traffic data) it is important to James, David, Jeff, Joshua, Anna Blake, Elizabeth and Peter to get the data in time (because each of these consumers has the attribute that once he has arrived home the data is worthless) therefore the second content item gets a maximum priority of 100. For the third content item (entertainment data) all of the consumers (Jill, John, Armand, Marianne or James) have the attribute that they must make entertainment arrangements before dinner and entertainment information is useless afterwards. Therefore, delivery of the third content item to each of the consumers has a maximum priority of 120. Concerning delivery of the fourth content item (news clips), Elizabeth, Peter, Bessie, Gertrude, and Deborah all have the attribute that if they do not get the fourth content item on time, they can view the item later in the evening. Thus, the maximum priority for the fourth content item for Elizabeth, Peter, Bessie, Gertrude, and Deborah is 80. On the other hand, Frank, Celia, Jill, John, Armand and Marianne, have the attribute that they watch the news later in the night. If a news clip is not immediately available, they will just go to bed and not watch the clip. Furthermore the fourth content item has the nature of being a very large file of multiple video clips. Delivery of large files is easily disrupted. Therefore both because of the attribute of the consumers and because of the nature of the fourth content item, the maximum priority for the fourth content item is different for different consumers. Particularly, the maximum priority for delivery of the fourth content item to Frank, Celia, Jill, John, Armand and Marianne is set high at 180. According to the above priority scheme, the priority of the delivery for the first content item at any time before 15:00 (line 802a) is 120−60(t−15) where t is the time in hours. Particularly at the beginning of the time span of FIG. 8 (14:00) the priority of delivery the first content item to Frank, Celia, Jill, John, Armand and Marianne is 120−60(15−14)=60. The priority for delivery of the second content item to James, David, Jeff, Joshua, Anna Blake, Elizabeth and Peter before 16:30 is 100−60(16.5−t). The priority for delivery of the third content item to Jill, John, Armand, Marianne and James before 18:30 is 120−60(18.5−t). The priority for delivery of the fourth content item to Elizabeth, Peter, Bessie, Gertrude, and Deborah before 16:00 is 80-60(16−t). The priority for delivery of the fourth content item to Frank, Celia, Jill, John, Armand and Marianne before 20:00 is 180−60(20−t). Thus we see that prior to 15:00, delivery of the first content item has top priority and all instances of the first content item are sent out before sending out any other item. For two items of equal priority, the rule is that the top name on the list of FIG. 8 receives first. Thus since John, Frank, Celia and Jill all have the same priority for the first content item, they receive in the order of the list (John, Frank, Celia and Jill) as is shown in FIG. 8. After the first content item has been sent out, delivering the second content item to James, David, Jeff, Joshua, Anna Blake, Elizabeth and Peter has top priority. Once all instances of the second content item have been delivered, even though the optimal notification time 18:00 for sending the fourth content item to Elizabeth, Peter, Bessie, Gertrude, and Deborah is earlier than optimal notification time 18:30 for sending the third content item to Jill, John, Armand, Marianne and James, nevertheless the top priority goes to sending the third content item to Jill, John, Armand, Marianne and James because the difference in maximum priorities 120−80=40 is greater than the difference in times 60(18.5−18)=30. Thus, first all of the third content item is sent to Jill, John, Armand, Marianne and James and then the fourth item is sent to Elizabeth, Peter, Bessie, Gertrude, and Deborah and finally the fourth item is sent to Frank, Celia, Jill, John, Armand and Marianne.

Alternatively, a critical time of delivery may differ from the optimal time of notification (for example if congestion is expected on the delivery channel before the optimal time of notification, then the critical time for delivery is before the expected congestion and well before the optimal time for notification). When the critical time for delivery is different from the optimal time for notification, the priority of a delivery is based on the optimal time for delivery.

While the disclosure has been described with respect to a limited number of embodiments, it will be appreciated that many variations, modifications and other applications of the disclosure may be made.

What is claimed is:

1. A method of electronic content delivery, the method comprising:
determining a peak demand period associated with a requested content item;
encrypting the requested content item;
identifying a local storage of a media device using an identification algorithm; and
transmitting the requested content item to the media device prior to an airing of an advertisement associated with the requested content item and prior to the peak demand period, wherein the requested content item is delivered to the local storage prior to the peak demand period, and wherein the content item is to be decrypted prior to being displayed by the media device.

2. The method of claim 1, wherein the requested content item is selected for preload to the local storage based at least on a comparison of a threshold volume to a background noise volume associated with the requested content item.

3. The method of claim 1, wherein the local storage is selectively identified for preload via an output of the identification algorithm.

4. The method of claim 3, wherein the identification algorithm is configured to selectively identify the local storage based on a location of the local storage.

5. The method of claim 3, wherein the identification algorithm is configured to selectively identify the local storage based on a presence of a user at an event associated with the requested content item.

6. The method of claim 3, wherein the identification algorithm is configured to selectively identify the local storage based on a pertinence of the requested content item to content displayed by the media device.

7. The method of claim 3, wherein the identification algorithm is configured to selectively identify the local storage based on an artist that is associated with the requested content item.

8. The method of claim 1, wherein the content item is sealed into a packaged item prior to delivery to the media device.

9. The method of claim 1, further comprising determining if there is available space in the local storage prior to delivery of the requested content item to the media device.

10. The method of claim 8, wherein the packaged item is sent to the local storage using a low-load opportunity windows on a communication channel using broadcasting bursts.

11. The method of claim 1, wherein the content item is restricted from use by the media device before being released.

12. The method of claim 1, wherein based on a successful predictive identification of a user, and determining that the content item has already been delivered to the local storage 118, the media device, upon a user requests playback of the content item upon release of the content item.

13. The method of claim 1, wherein the media device is a mobile phone or a set top box.

14. The method of claim 1, wherein the content item is stored in consignment at the local storage.

15. The method of claim 1, wherein the content item is displayable upon receipt of a key from a publisher.

16. The method of claim 1, wherein a content item request is initiated responsive to a single key input of a user while a broadcast associated with the content item is presented on a second medium.

17. The method of claim 1, wherein a one click service is associated with a media file stored in the local storage.
